(19) United States
(12) Patent Application Publication
(10) Pub. No.: US 2012/0011220 A1
(43) Pub. Date: Jan. 12, 2012

(54) INFORMATION SEARCH SYSTEM, INFORMATION PROCESSING APPARATUS, AND TERMINAL APPARATUS

(75) Inventor: Teruki KOJIMA, Kawasaki (JP)

(73) Assignee: FUJITSU LIMITED, Kawasaki (JP)

(21) Appl. No.: 13/105,100

(22) Filed: May 11, 2011

(30) Foreign Application Priority Data
Jul. 6, 2010 (JP) 2010-153964

(51) Int. Cl. G06K 9/46; G06F 15/16

(52) U.S. Cl. 709/217; 382/190

(57) ABSTRACT

An information search system is connected to a search server that searches for information. The information search system includes a first apparatus and a second apparatus. The first apparatus selects a particular image from among images displayed on the second apparatus and specifies a range within the particular image. The second apparatus transmits a character recognized in the range within the particular image specified by the first apparatus to the search server.

### CROSS-REFERENCE TO RELATED APPLICATIONS

This application is based upon and claims the benefit of priority from the prior Japanese Patent Application No. 2010-153964 filed on Jul. 6, 2010, the entire contents of which are incorporated herein by reference.

### FIELD

Various embodiments described herein relate to an information search system, an information processing apparatus, and a terminal apparatus.

### BACKGROUND

An information processing apparatus having a television function of displaying a television broadcast is known. When trying to perform a search using information displayed in a television broadcast, a user who is watching the television broadcast on the information processing apparatus memorizes search information in order to perform an information search using the information processing apparatus.

In the case where a user memorizes search information in order to perform a search, the user might forget the search information. So as not to forget information, a user separately prepares a video recorder or the like and records a television broadcast on the video recorder or the like, and then, after the end of the broadcast, searches the recorded movie for the search information. Alternatively, the user separately prepares another information processing apparatus different from that for the television broadcast and performs an information search while watching the television broadcast.

However, it is expensive to prepare an information processing apparatus for searching information separately from an information processing apparatus having a television function. In addition, when a plurality of persons are watching a television broadcast displayed on a single information processing apparatus, if a person begins an information search with the information processing apparatus, the information search interrupts the other persons who are still watching the television broadcast.

### SUMMARY

According to an embodiment, an information search system is connected to a search server that searches for information. The information search system includes a first apparatus and a second apparatus. The first apparatus selects a particular image from among images displayed on the second apparatus and specifies a range within the particular image. The second apparatus transmits a character recognized in the range within the particular image specified by the first apparatus to the search server.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

Additional aspects and/or advantages will be set forth in part in the description which follows and, in part, will be apparent from the description, or may be learned by practice of the various embodiments.

### BRIEF DESCRIPTION OF THE DRAWINGS

FIG. 1 illustrates an example of an information search system;

FIG. 2 illustrates an example of an information processing apparatus;

FIG. 3 illustrates an example of the hardware configuration of a terminal apparatus;

FIG. 4 illustrates an example of a storage unit of the terminal apparatus;

FIG. 5 illustrates an example of the terminal apparatus;

FIG. 6 illustrates an example of the hardware configuration of the information processing apparatus;

FIG. 7 illustrates an example of a storage unit of the information processing apparatus;

FIG. 8 illustrates an example of an image obtaining process;

FIG. 9 illustrates an example in which a process for transmitting coordinates information is performed;

FIG. 10 is a diagram illustrating an example of a character recognition process performed by the information processing apparatus;

FIG. 11 illustrates a specific example of the results of a search;

FIG. 12 illustrates an example of an image of the results of the search of FIG. 11;

FIG. 13 illustrates an example of the processing flow of the information search system; and

FIG. 14 illustrates an example of the processing flow of the character recognition process.

### DETAILED DESCRIPTION OF THE EMBODIMENTS

Embodiments will be described hereinafter in order of the following sections: (1) Information Search System, (2) Terminal Apparatus, (3) Information Processing Apparatus, (4) Image Obtaining Process, (5) Coordinates Information Transmission Process, (6) Character Recognition Process, (7) Search Process, and (8) Processing Flow of Information Search System. An information search system (1) that will be described later has a terminal apparatus (2) and an information processing apparatus (3) that includes the terminal apparatus (2). The terminal apparatus (2) executes a process for requesting to obtain an image as part of an image obtaining process (4) and a coordinates information transmission process (5). The information processing apparatus (3) executes a process for transmitting a particular image as part of the image obtaining process (4), a character recognition process (6), and a search process (7). The information search system (1) executes the search process (7) in accordance with a certain processing flow (8).

### (1) Information Search System

First, an information search system and each element connected to the information search system will be described.

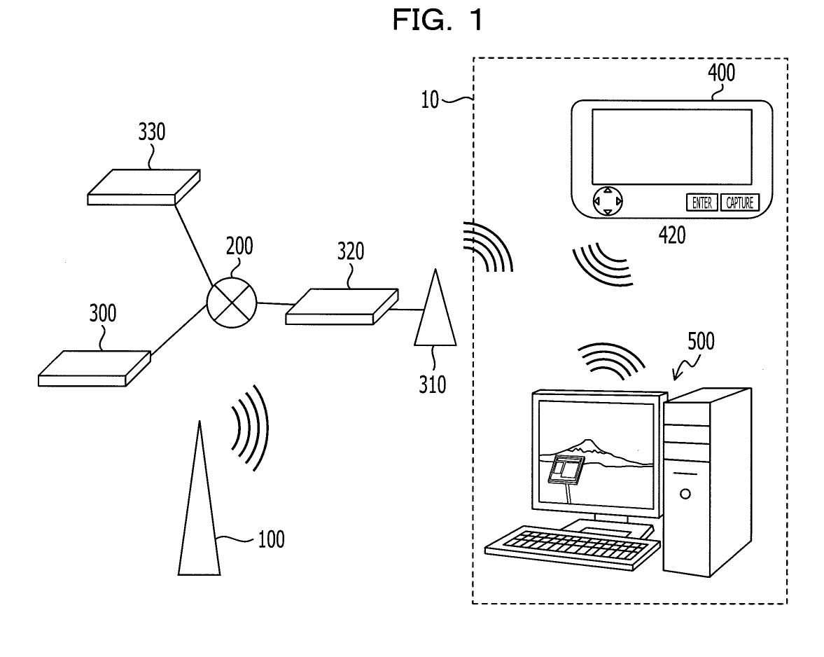

FIG. 1 illustrates an example of the information search system. An information search system 10 illustrated in FIG. 1 has a terminal apparatus 400 and an information processing apparatus 500. The information search system 10 selects a particular image from among images displayed on the information processing apparatus 500 using the terminal apparatus 400 and uses characters in the range within the particular image specified by the terminal apparatus 400 as search information. Therefore, the information search system 10 provides a function with which information included in an image can be easily used for a search.

The terminal apparatus 400 and the information processing apparatus 500 transmit and receive data to and from each other by utilizing wireless communication. The wireless communication herein may be, for example, wireless communication that complies with a standard such as Bluetooth (registered trademark). The information processing apparatus 500 is connected to a search server 300 through the Internet 200.

An access point 310 is connected to the information processing apparatus 500 or the terminal apparatus 400 through wireless communication and functions as a network switch. The access point 310 is connected to a proxy server 320 through an optical cable or the like and provides the information processing apparatus 500 or the terminal apparatus 400 with access based on the physical layer or the data link layer of the Open Systems Interconnection (OSI) reference model. It is to be noted that although the information processing apparatus 500 is connected to the access point 310 through wireless communication in FIG. 1, the information processing apparatus 500 may be connected to the access point 310 through a cable.

A television transmitting antenna 100, which is a television transmitting station of a television network or the like, transmits a television broadcast to the information processing apparatus 500. The television transmitting antenna 100 transmits a television broadcast, which includes broadcast signals, using a particular frequency band such as the very high frequency (VHF) or the ultrahigh frequency (UHF). A television broadcast will be referred to as a “TV broadcast” hereinafter.

The proxy server 320, a web server 330, and the search server 300 are connected to the Internet 200. The proxy server 320 executes, for example, a process for changing a global Internet Protocol (IP) address thereof to an IP address of the information processing apparatus 500 or the terminal apparatus 400 and provides access to the Internet 200 based on the IP address of the information processing apparatus 500 or the terminal apparatus 400.

Upon receiving search information from the information search system 10, the search server 300 provides a source of the search information with a piece of information relating to the search information from among pieces of information stored in servers connected to the Internet 200. The search information may be, for example, a search string or an image. The search server 300 executes search engine software to collect information disclosed on the Internet 200 by the web server 330 and the like. The search server 300 then compiles a database of the collected information and provides a service in which the information can be searched for using a character string or an image. It is to be noted that although a single web server 330 is illustrated in FIG. 1 as an example, there are a plurality of web servers 330 connected to the Internet 200.

If the search information is a character string, the search server 300 searches for a Uniform Resource Locator (URL) of a web server 330 that provides information including the search string or the like by, for example, performing an n-gram search on a database thereof, and transmits the results of the search to the source of the search information.

If the search information is an image, the search server 300 executes an image recognition function with which an amount of characteristic such as a characteristic parameter or a characteristic vector is obtained from the image. The search server 300 then searches for an image that is registered in the database thereof and that has an amount of characteristic in order to search for the URL of a web server 330 that provides information including an image having an amount of characteristic similar to that of the image, which is the search information, and to transmit the results of the search to the source of the search information.

As well as displaying images of a TV broadcast and the like, the information processing apparatus 500 transmits a particular image obtained from among images displayed on a display device thereof to the terminal apparatus 400 in accordance with a request to obtain an image received from the terminal apparatus 400. By the request to obtain an image, an image is selected. In addition, the information processing apparatus 500 transmits characters recognized in a range within an image specified by coordinates information received from the terminal apparatus 400 to the search server 300 as search information. The coordinates information specifies a range within a particular image.

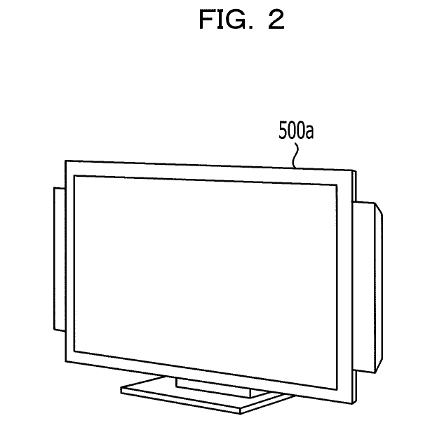

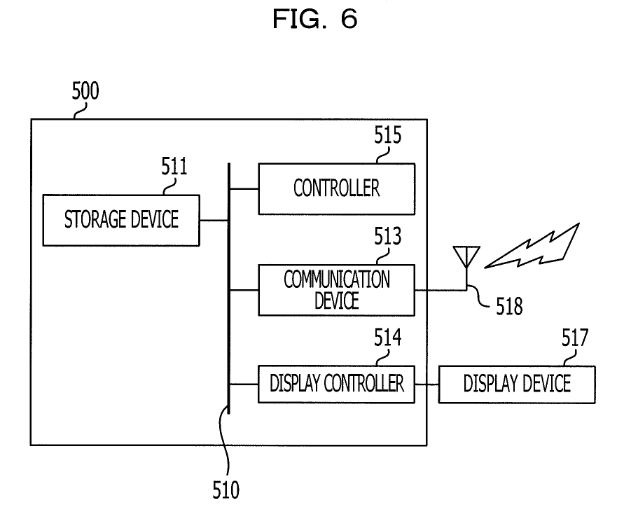

FIG. 2 illustrates an example of the information processing apparatus 500. Although the information processing apparatus 500 in FIG. 1 is illustrated as a desktop computer, the information processing apparatus 500 may be an information processing apparatus 500a having a shape of a television set as illustrated in FIG. 2. An example of the hardware configuration of the information processing apparatus 500 will be described later with reference to FIG. 6.

The terminal apparatus 400 transmits a request to obtain an image in order to allow a user who is using the terminal apparatus 400 to select an image from a movie displayed by the information processing apparatus 500. If a screen with which the user wishes to perform an information search is displayed while the user is watching a TV broadcast on the information processing apparatus 500, the user operates an input unit 420 of the terminal apparatus 400 to perform an operation for selecting an image. That is, the particular image selected by the request to obtain an image is an image that appears in a TV broadcast and with which the user wishes to perform an information search.

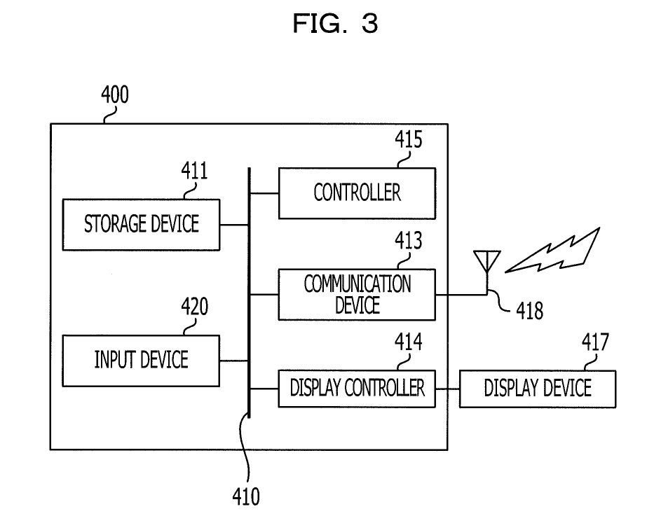

Upon receiving the particular image selected by the request to obtain an image, the terminal apparatus 400 displays the particular image on a display device thereof and transmits, to the information processing apparatus 500, the coordinates information that indicates a range within the particular image input by the user who has operated the input unit 420. An example of the hardware configuration of the terminal apparatus 400 will be described later with reference to FIG. 3.

### (2) Terminal Apparatus

The hardware configuration of the terminal apparatus 400 and the information processing apparatus 500 included in the information search system 10 will be described.

FIG. 3 illustrates an example of the hardware configuration of the terminal apparatus 400. As illustrated in FIG. 3, the terminal apparatus 400 includes a controller 415, a storage unit 411, the input unit 420, a communication device 413, a display controller 414, and a display device 417. The controller 415 performs data communication with each of the above-mentioned units through a data bus 410.

Upon receiving a request to obtain an image from the input unit 420, the controller 415 performs a process for requesting to obtain an image. In the process for requesting to obtain an image, the communication device 413 is controlled in such a way as to transmit the request to obtain an image to the information processing apparatus 500. When the terminal apparatus 400 has received a selected particular image from the information processing apparatus 500 in response to the request to obtain an image, the controller 415 performs a process for displaying the particular image on the display device 417. Upon receiving coordinates information from the input unit 420, the controller 415 performs a coordinates information transmission process. The coordinates information specifies a range within the particular image input by the user who has operated the input unit 420. In the coordinates information transmission process, the communication device 413 is controlled in such a way as to transmit the coordinates information to the information processing apparatus 500.

The controller 415 executes a program stored in the storage unit 411 to perform each of the above-described processes. The controller 415 is, for example, a central processing unit (CPU). The controller 415 includes a cache memory. An instruction execution unit in the controller 415 causes the cache memory to temporarily hold frequently accessed data during execution of each process. In addition, the controller 415 executes web browser software stored in the storage unit 411 and provides an Internet access function through the Hypertext Transfer Protocol (HTTP).

The terminal apparatus 400 may have a drive apparatus, which is not illustrated. The drive apparatus reads data from or writes data to a storage medium such as, for example, a floppy (registered trademark) disk, a compact disc read-only memory (CD-ROM), or a digital versatile disc (DVD). The drive apparatus includes a motor that rotates a storage medium and a head that reads data from and writes data to a storage medium. A storage medium can store a program. The controller 415 stores a program read by the drive apparatus in the storage unit 411. Thus, the storage unit 411 stores the program.

The storage unit 411 stores a program to be executed by the controller 415. The storage unit 411 also stores data regarding a screen image displayed on the display device 417 of the terminal apparatus 400.

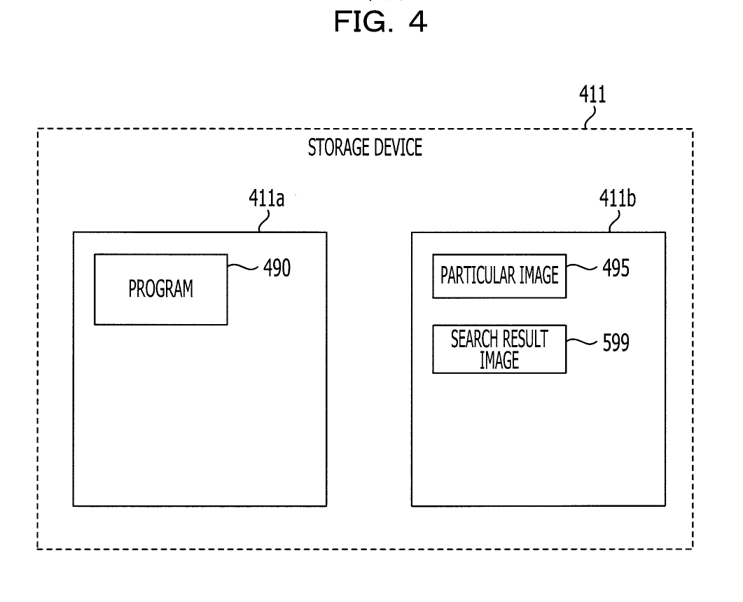

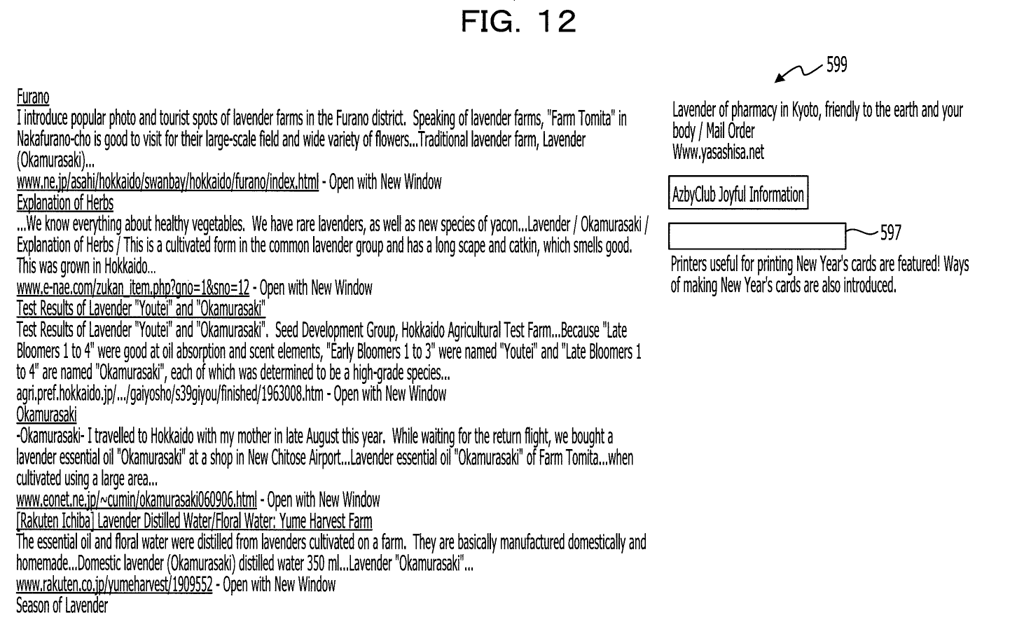

FIG. 4 illustrates an example of the storage unit 411 of the terminal apparatus 400. As illustrated in FIG. 4, the storage unit 411 may be formed of a single-port random-access memory (RAM) 411a that stores programs and a dual-port video RAM (VRAM) 411b that stores data regarding screen images. The RAM 411a stores a program 490 to be executed by the controller 415. In the VRAM 411b, a particular image 495 selected by a request to obtain an image and a search result image 599, which is obtained by removing information other than a search string from search information, are temporarily saved. The search result image 599 will be described later with reference to FIG. 12.

The input unit 420 illustrated in FIG. 3 has, for example, arrow keys for specifying the range, an image obtaining button, and a range determining button. When the user presses the image obtaining button in order to select a particular image from a movie displayed on the display device of the information processing apparatus 500, the input unit 420 outputs an input made by pressing the image obtaining button as a request to obtain an image. The user then selects, on an image displayed on the display device 417 of the terminal apparatus 400, coordinates information, which is a display range input obtained by selecting the range in which an image or a text in a particular image with which the user tries to perform an information search using a search engine is displayed using the arrow keys for specifying the range, and presses the range determining button. The input unit 420 outputs the coordinates information, which is a display range input selected by using the arrow keys for specifying the range, to the controller 415.

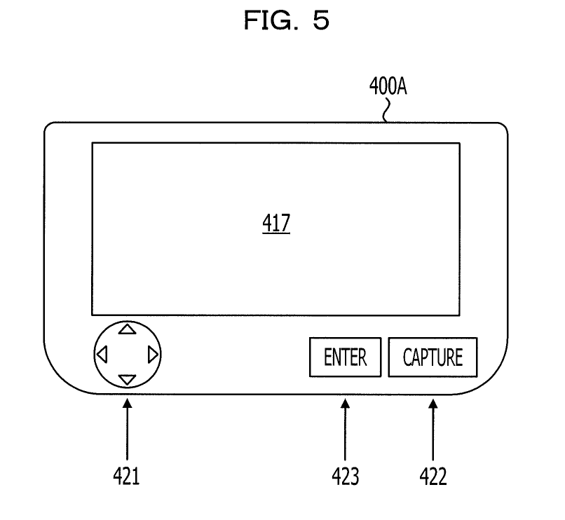

FIG. 5 illustrates an example of the terminal apparatus 400. A terminal apparatus 400A illustrated in FIG. 5 includes a display device 417, arrow keys 421 for specifying the range, an image obtaining button 422, and a range determining button 423, which have been described above. As illustrated in FIG. 5, a word “Capture” is shown on the image obtaining button 422 and a word “Enter” is shown on the range determining button 423.

The display controller 414 is connected to the display device 417. The display controller 414 generates a display drive signal for driving the display device 417 on the basis of an image signal (for example, a YUV signal or an RGB signal) transmitted from the controller 415, and supplies the display device 417 with the display drive signal. The display device 417 displays an image in accordance with the display drive signal. The display device 417 is, for example, a display device such as a liquid crystal display (LCD) or an organic electroluminescence display.

The display device 417 is, for example, a capacitive touch panel display. A capacitive touch panel has a conductive film and a detection circuit. The detection circuit detects a change in current caused by a change in the capacitance between a fingertip and the conductive film and then detects the position of the fingertip on the conductive film by calculating the position at which the capacitance has changed. The conductive film is transparent and allows image information displayed on a display arranged under the touch panel to transmit therethrough. The display device 417, which is a touch panel display, has both a touch panel function and a display function.

Thus, since the display device 417, which is a touch panel display, has the touch panel function, a part of the display device 417 may serve as the input unit 420 described above.

The communication device 413 illustrated in FIG. 3 has a function of receiving wireless signals including visual or audio data and obtaining the visual or audio data, which is a digital signal, from the received wireless signals. The communication device 413 has an antenna 418 and receives a radio wave through the antenna 418. After performing a baseband process including an analog-to-digital conversion, a Fourier transform, and de-spreading, the communication device 413 performs a digital signal process in which a radio wave in a particular frequency band is extracted. The communication device 413 also serves as a network interface card (NIC) for performing the Transmission Control Protocol (TCP)/IP processes, and provides access to the Internet 200.

### (3) Information Processing Apparatus

FIG. 6 illustrates an example of the hardware configuration of the information processing apparatus 500. As illustrated in FIG. 6, the information processing apparatus 500 includes a controller 515, a storage unit 511, a communication device 513, a display controller 514, and a display device 517. The controller 515 performs data communication with each of the above-mentioned units through a data bus 510.

Upon receiving a request to obtain an image from the terminal apparatus 400, the controller 515 performs a process for transmitting a particular image. In the process for transmitting a particular image, the communication device 513 is controlled in such a way as to obtain, from a movie displayed on the display device 517, the particular image selected by the request to obtain an image and to transmit the particular image to the terminal apparatus 400. It is to be noted that, in an image obtaining process performed by the controller 515, a particular image may be obtained using a time at which the image obtaining button 422 is pressed, which is included in the particular image. In addition, when the controller 515 obtains an image, the information processing apparatus 500 and the terminal apparatus 400 may perform time synchronization through wireless communication. Thus, by including the concept of time in the request to obtain an image, it is possible to obtain an image that is no longer displayed in a TV broadcast on the information processing apparatus 500 but is stored in the storage unit 511.

Furthermore, upon receiving coordinates information from the terminal apparatus 400, the controller 515 performs a search information transmission process. In the search information transmission process, the communication device 513 is controlled in such a way as to transmit a range within the particular image (hereinafter referred to as a “search-target image”) specified by the coordinates information to the search server 300 as search information.

Furthermore, the controller 515 executes a character recognition process for recognizing characters in the search-target image.

In the character recognition process, the controller 515 divides the range within the particular image into certain regions.

The controller 515 then binarizes the divided regions and extracts character elements from the divided regions. Data obtained by quantifying the characteristics of the extracted character elements and data regarding an amount of characteristic obtained by quantifying the characteristics of standard characters stored in the storage unit 511 are subjected to matching, thereby recognizing individual characters included in the input image. If the matching ratio is equal to or more than a certain value, the controller 515 judges that the character recognition has been successful (hereinafter may be referred to as “correct recognition”) and then transmits the recognized characters to the search server 300 as a search string, thereby utilizing a word search performed by the search server 300.

In addition, instead of performing character recognition on a search-target image, the controller 515 may transmit the search-target image to the search server 300 and utilize an image recognition function of the search server 300.

There may be a case in which there are no characters in an image with which the user wishes to perform an information search. For example, when the user wants to visit a beautiful beach displayed on a television screen, no result can be obtained from an information search in the case of the character recognition process if there are no characters that indicate the name of the beach. However, when the image recognition function of the search server 300 is utilized, the information processing apparatus 500 transmits a search-target image that indicates the beautiful beach to the search server 300 and can obtain a result of the search from the search server 300 that, for example, the beach is located in Maldives. In addition, when the user becomes interested in a person displayed on a television screen, there may be a case in which the name of the person is not displayed on the screen. In that case, too, the information processing apparatus 500 transmits a search-target image including the person to the search server 300 and can obtain the name of the person from the search server 300 as a result of the search.

In addition, the correct recognition ratio of character recognition may be decreased depending on the search-target image. For example, there may be a case in which, even if there is an image of characters in a search-target image, the characters are significantly unclear or displayed obliquely. In that case, the controller 515 cannot correctly recognize the characters and accordingly cannot transmit a search string to the search server 300. However, the controller 515 transmits the search-target image to the search server 300 as it is and utilizes the image recognition function of the search server 300. In doing so, the user can obtain information from the search server 300 with respect to the image with which the user wishes to perform an information search.

The controller 515 may perform a filtering process on a search string on the basis of search results 598 in order to delete information that is not related to the search string, and may generate a search result image 599 to be transmitted to the terminal apparatus 400. In doing so, since information that is not related to the search string has been deleted from the search result image 599, the user can easily recognize the results of the search that are related to information included in a movie.

The controller 515 is, for example, a CPU. The controller 515 includes a cache memory. An instruction execution unit in the controller 515 causes the cache memory to temporarily hold frequently accessed data during execution of each process.

The storage unit 511 stores a program to be executed by the controller 515. The storage unit 511 also temporarily stores an image obtained by the communication device 513.

It is to be noted that, as is the case with the terminal apparatus 400, the information processing apparatus 500 may have a drive apparatus, which is not illustrated. The drive apparatus reads data from or writes data to a storage medium such as, for example, a floppy (registered trademark) disk, a CD-ROM, or a DVD. The controller 515 stores a program read from the storage medium by the drive apparatus in the storage unit 511. Thus, the storage unit 511 stores the program.

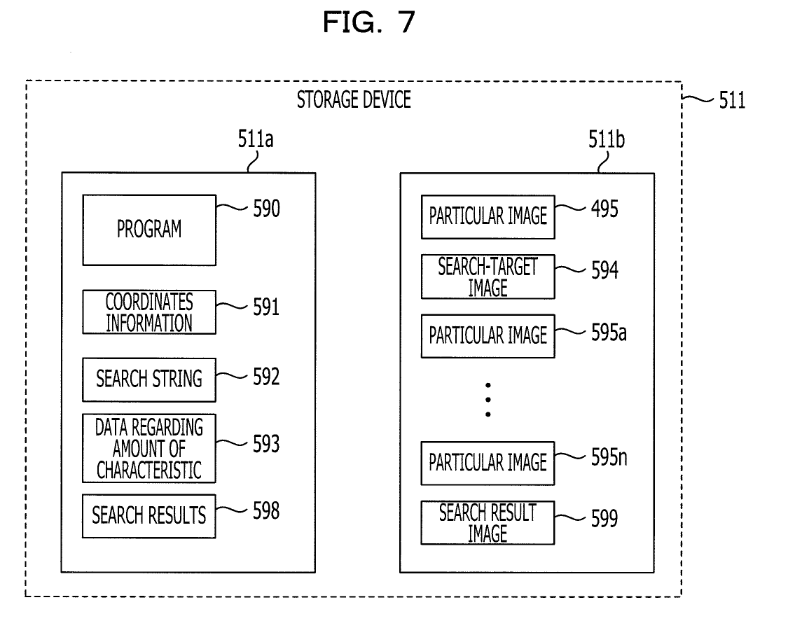

FIG. 7 illustrates an example of the storage unit 511 of the information processing apparatus 500. As illustrated in FIG. 7, the storage unit 511 may be formed of a single-port RAM 511a that stores programs and a dual-port VRAM 511b that stores data regarding screen images. The RAM 511a stores a program 590 to be executed by the controller 515, coordinates information 591 transmitted from the terminal apparatus 400, a search string 592 recognized in the character recognition process, data 593 regarding an amount of characteristic of the standard characters, and the search results 598. In the VRAM 511b, a particular image 495 selected by a request to obtain an image, a search-target image 594 cut out from the particular image 495 in accordance with the coordinates information 591, and the search result image 599 are temporarily saved. Furthermore, in the VRAM 511b, images 595a to 595n for a movie that are included in the movie obtained from a TV broadcast are saved in a first-in first-out (FIFO) manner.

It is to be noted that the search string 592 may be permanently stored in the storage unit 511 and utilized later as preference data.

The communication device 513 illustrated in FIG. 6 has the same function as the communication device 413, which has been described above, in order to perform communication with the communication device 413 of the terminal apparatus 400, the web server 330, or the search server 300. The communication device 513 also has an antenna 518 for receiving a TV broadcast and an antenna tuner, with which the communication device 513 receives a TV broadcast. The antenna tuner causes the antenna 518 to resonate at the frequency of a specified channel in order to achieve impedance matching with the antenna 518, thereby operating in such a way as to increase the efficiency of the power received from the antenna 518.

The display controller 514 is connected to the display device 517. The display controller 514 generates a display drive signal for driving the display device 517 on the basis of an image signal (for example, a YUV signal or an RGB signal) transmitted from the controller 515, and supplies the display device 517 with the display drive signal. The display device 517 displays an image in accordance with the display drive signal. The display device 517 is, for example, a display device such as an LCD, an organic electroluminescence display, or a plasma display.

### (4) Image Obtaining Process

As the image obtaining process, the process for requesting to obtain an image performed by the terminal apparatus 400, the process for transmitting a particular image performed by the information processing apparatus 500, and the process for displaying a particular image performed by the terminal apparatus 400 will be described.

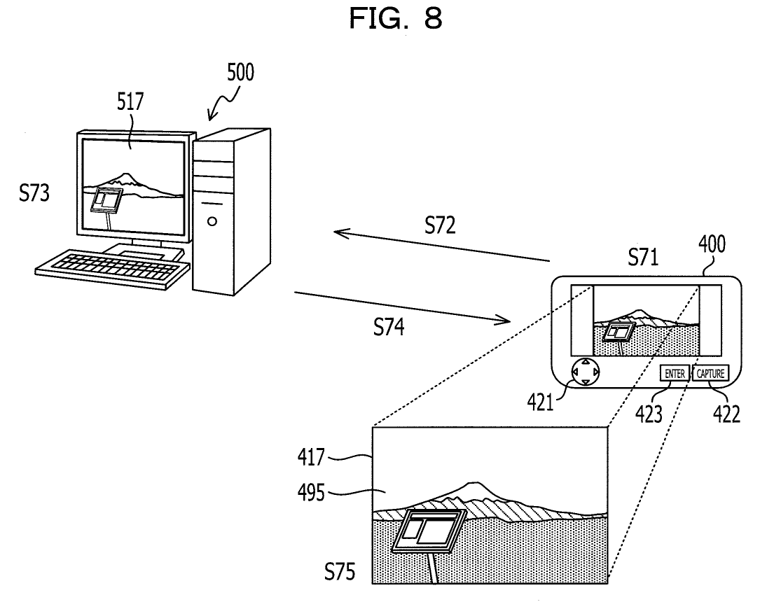

FIG. 8 is a diagram illustrating an example of the image obtaining process. S71 to S75 illustrated in FIG. 8 indicate data communication or information processing performed in the image obtaining process. It is to be noted that, before this process is started, the information processing apparatus 500 is displaying a TV broadcast and is waiting for a request to obtain an image from the terminal apparatus 400. The terminal apparatus 400 is turned on and can be operated. The examples illustrated in FIGS. 8 to 11 are examples in which the information processing apparatus 500 is displaying a travel program, and a user finds a scene he/she is interested in and obtains search information using the terminal apparatus 400 on the basis of information “Lavender Okamurasaki” included in the scene.

First, upon the image obtaining button 422 being operated, the terminal apparatus 400 receives a request to obtain an image from the input unit 420 (S71). The controller 415 controls the communication device 413 in such a way as to perform a process for requesting to obtain an image, where the request to obtain an image is transmitted to the information processing apparatus 500 (S72).

When the information processing apparatus 500 receives the request to obtain an image from the terminal apparatus 400 (S72), the controller 515 selects a particular image 495 selected by the request to obtain an image from a movie displayed on the display device 517 and temporarily stores the particular image 495 in the VRAM 511b (S73). The controller 515 then controls the communication device 513 in such a way as to transmit the particular image 495 to the terminal apparatus 400 (S74).

When the terminal apparatus 400 receives the particular image 495 selected by the request to obtain an image from the information processing apparatus 500 (S74), the controller 415 performs a process for displaying the particular image 495 on the display device 417 (S75). The particular image 495 illustrated in FIG. 8 is an example of a particular image displayed on the display device 417.

### (5) Coordinates Information Transmission Process

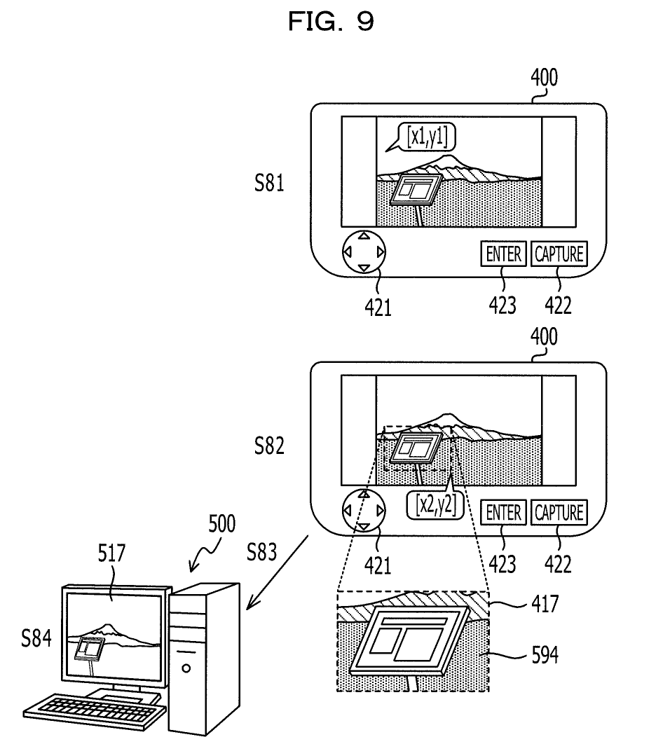

The coordinates information transmission process will be described. FIG. 9 illustrates an example of the coordinates information transmission process. S81 to S84 illustrated in FIG. 9 indicate data communication or information processing performed in the coordinates information transmission process.

The user of the terminal apparatus 400 operates the arrow keys 421 for specifying the range in order to move the cursor to the upper-left coordinates [x1, y1] of an image he/she wants to cut out and presses the range determining button 423 to determine the coordinates [x1, y1] as the start position of a range within a search image (S81).

After that, the user of the terminal apparatus 400 operates the arrow keys 421 for specifying the range in order to move the cursor to the lower-right coordinates [x2, y2] of the image he/she wants to cut out and presses the range determining button 423 to determine the coordinates [x2, y2] as the end position of the range within the search image (S82). The terminal apparatus 400 transmits coordinates information determined in S81 and S82 to the information processing apparatus 500 through the communication device 513 by wireless communication. A search-target image 594 illustrated in FIG. 9 is an example of a search-target image specified by coordinates information displayed on the display device 417.

The information processing apparatus 500 receives the coordinates information from the terminal apparatus 400 (S83). The information processing apparatus 500 then stores the search-target image 594 specified by the coordinates information in the VRAM 511b (S84).

### (6) Character Recognition Process

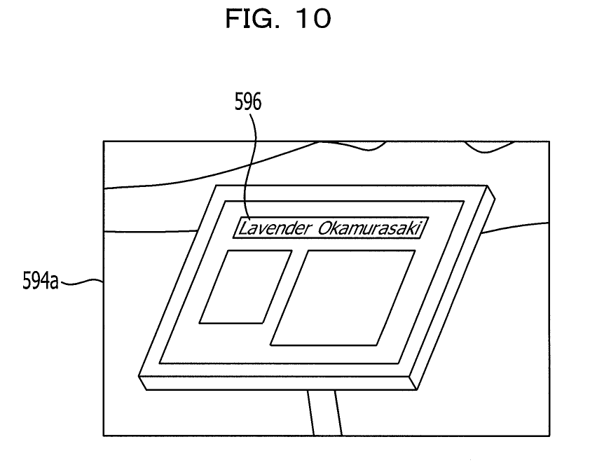

FIG. 10 is a diagram illustrating an example of the character recognition process performed by the information processing apparatus 500. In the character recognition process performed by the controller 515, a search-target image is binarized and character elements are extracted from the search-target image. A search-target image 594a illustrated in FIG. 10 is an image obtained by binarizing the search-target image 594. Character elements 596 illustrated in FIG. 10 are character elements extracted by the controller 515. The controller 515 performs matching of the character elements 596 and data 593 regarding an amount of characteristic in order to correctly recognize the characters, and obtains the information “Lavender Okamurasaki” from the search-target image 594 as a search string.

### (7) Search Process

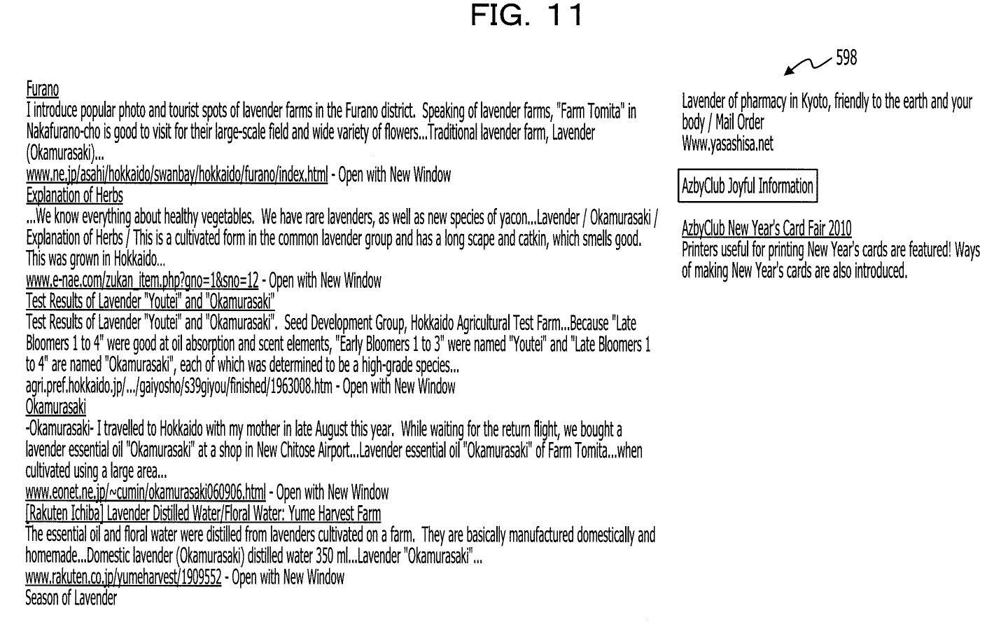

FIG. 11 is a diagram illustrating an example of search information. Search results 598 illustrated in FIG. 11 are information obtained from the search server 300 as a search string by using the information “Lavender Okamurasaki”. As illustrated in FIG. 11, as search information relating to “Lavender Okamurasaki”, a place “Furano”, “Explanation of Herbs”, “Okamurasaki”, and the like are shown. As described above, the search results 598 are stored in the RAM 511a.

FIG. 12 is a diagram illustrating an example of a search result image. A search result image 599 illustrated in FIG. 12 is an image from which information 597 other than information relating to the search string has been removed.

### (8) Processing Flow of Information Search System

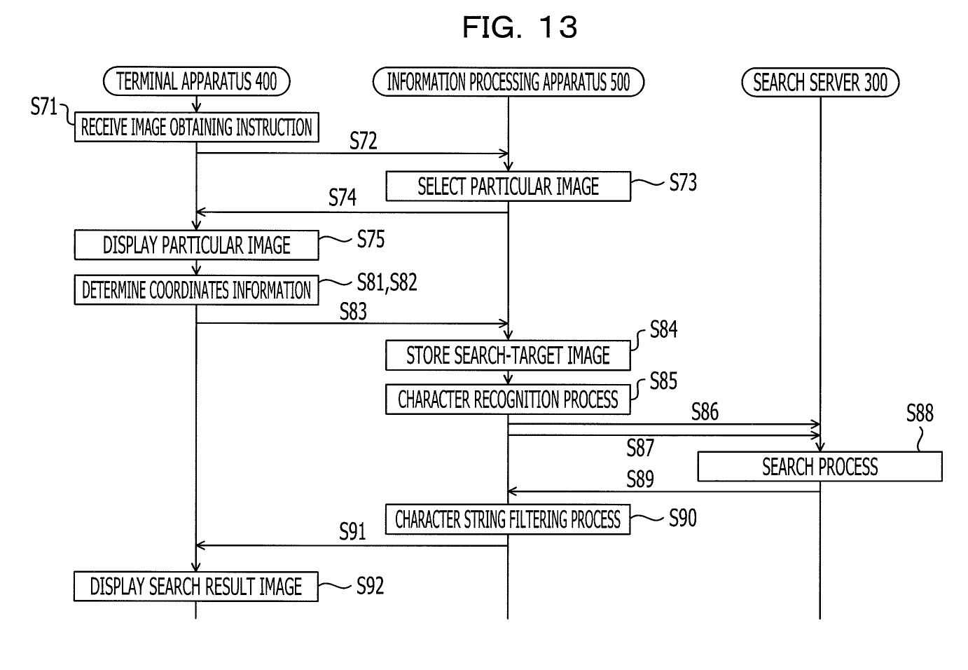

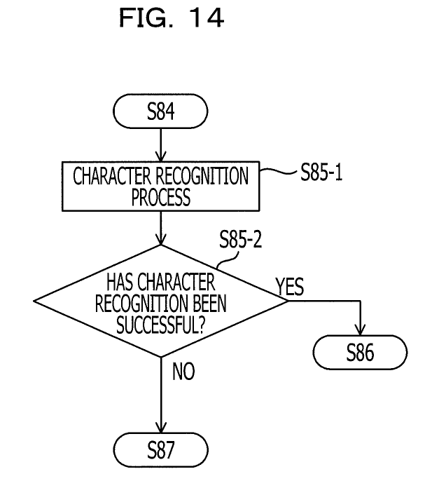

FIG. 13 illustrates an example of the processing flow of the information processing apparatus 500. FIG. 14 illustrates an example of the processing flow of the character recognition process. S71 to S84 illustrated in FIG. 13 are the same as those described with reference to FIG. 8 or FIG. 9, and therefore description thereof is omitted.

The information processing apparatus 500 executes the character recognition process on a search-target image (S85). In order to describe S85, FIG. 14 is referred to. When the character recognition process illustrated in FIG. 14 is executed (S85-1), the controller 515 judges whether or not the character recognition has been successful (S85-2). If the character recognition has been successful (S85-2: YES), the information processing apparatus 500 transmits the recognized character string to the search server 300 as a search string (S86). If the character recognition cannot be performed due to a matching ratio equal to or lower than a certain value (S85-2: NO), the information processing apparatus 500 transmits the search-target image to the search server 300 (S87).

Referring back to FIG. 13, the search server 300 executes the search process using the search string or the search-target image (S88). The search server 300 transmits the search results 598 to the information processing apparatus 500 (S89).

Upon receiving the search results 598, the information processing apparatus 500 executes a character string filtering process for removing the search string from the search results 598 (S90). The information processing apparatus 500 transmits the search result image 599, from which the search string has been removed, to the terminal apparatus 400 (S91). Upon receiving the search result image 599, the terminal apparatus 400 displays the search result image 599 on the display device 417 (S92). The user then operates the input unit 420 to select a URL shown in the search result image 599 and obtain information stored in the web server 330 through the Internet 200, thus performing an information search using the terminal apparatus 400.

As described above, when watching television on the information processing apparatus 500, the user of the terminal apparatus 400 can perform an information search whenever he/she wants by recording information on the terminal apparatus 400. Therefore, the user need not memorize a search string, and accordingly can perform an information search without forgetting the search string. In addition, since an information search instruction is issued from the terminal apparatus 400 and search results are displayed on the terminal apparatus 400, the information search does not interrupt a person who is watching television on the information processing apparatus 500.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above may be non-transitory media.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An information search system connected to a search server that searches for information, the information search system comprising:
a first apparatus; and
a second apparatus,
wherein the first apparatus selects a particular image from among images displayed on the second apparatus and specifies a range within the particular image, and
wherein the second apparatus transmits a character recognized in the range within the particular image specified by the first apparatus to the search server.

2. The information search system according to claim 1,
wherein the first apparatus includes a first communication device that transmits and receives data and a first display device that is configured to display an image,
wherein the second apparatus includes a second communication device that transmits and receives data and a second display device that displays an image received by the second communication device,
wherein the first apparatus further includes a first controller that controls the first communication device in such a way as to transmit an image obtaining request, which selects a particular image from among images displayed on the second display device of the second apparatus, to the second apparatus, and to transmit, to the second apparatus, coordinates information for specifying a range within the particular image after displaying the particular image selected by the image obtaining request transmitted from the first apparatus, and
wherein the second apparatus further includes a second controller that controls the second communication device in such a way as to transmit, to the first apparatus, the particular image obtained from among the images displayed on the second display device in accordance with the image obtaining request transmitted from the first apparatus, and to transmit, to the search server as search information, a character recognized in the range within the particular image specified by the coordinates information transmitted from the first apparatus.

3. The information search system according to claim 2, wherein the second controller transmits the range within the particular image specified by the coordinates information to the search server as the search information when the character is not recognized.

4. The information search system according to claim 2, wherein the second controller deletes information that is not related to the search information from a search result obtained from the search server.

5. An information processing apparatus comprising:
a communication device that transmits and receives data to and from a search server that searches for information and another apparatus;
a display device that displays an image received by the communication device; and
a controller that controls the communication device in such a way as to transmit, to the another apparatus, a particular image obtained from among images displayed on the display device in accordance with a particular image obtaining request, which selects a particular image from among the images displayed on the display device, when the particular image obtaining request is received from the another apparatus, and to transmit, to the search server as search information, a character recognized in a range within the particular image specified by coordinates information for specifying the range within the particular image when the coordinates information is received from the another apparatus.

6. The information processing apparatus according to claim 5, wherein the controller transmits the range within the particular image specified by the coordinates information to the search server as the search information when the character is not recognized.

7. The information processing apparatus according to claim 5, wherein the controller deletes information that is not related to the search information from a search result obtained from the search server.

8. A terminal apparatus comprising:
a communication device that transmits and receives data to/from another apparatus;
a display device that displays an image; and
a controller that controls the communication device in such a way as to transmit, to the another apparatus, an image obtaining request, which selects a particular image from among images displayed on the another apparatus, and to transmit, to the another apparatus, coordinates information for specifying a range within the particular image selected by the image obtaining request transmitted from the terminal apparatus after displaying the particular image on the display, and
wherein the another apparatus displays an image, obtains the particular image selected by the image obtaining request from the image upon receiving the image obtaining request from the terminal apparatus, and transmits, to a search server as search information, a character recognized in a range within the particular image specified by coordinates information for specifying the range within the particular image upon receiving the coordinates information.
